(19) United States
(12) Patent Application Publication
(10) Pub. No.: US 2008/0080772 A1
(43) Pub. Date: Apr. 3, 2008

(54) IMAGE PROCESSING DEVICE THAT EFFICIENTLY PERFORMS LOGARITHM CALCULATION IN RETINEX PROCESS

(75) Inventor: Masashi Kuno, Aichi-ken (JP)

Correspondence Address: SCULLY SCOTT MURPHY & PRESSER, PC, 400 GARDEN CITY PLAZA, SUITE 300, GARDEN CITY, NY, 11530, US

(73) Assignee: BROTHER KOGYO KABUSHIKI KAISHA, Aichi-ken (JP)

(21) Appl. No.: 11/863,926

(22) Filed: Sep. 28, 2007

(30) Foreign Application Priority Data
Sep. 28, 2006 (JP) 2006-264470

(51) Int. Cl. G06K 9/56

(52) U.S. Cl. 382/205

(57) ABSTRACT

A storage unit stores a table including a plurality of logarithmic values corresponding to respective ones of a plurality of antilogarithmic values. An antilogarithmic-value calculating portion divides a pixel value of a subject pixel in an original image by a peripheral average luminance of the subject pixel, thereby calculating a desired antilogarithmic value. A determining portion determines whether the desired antilogarithmic value is included in a predetermined range. A first logarithmic-value calculating portion calculates a desired logarithmic value corresponding to the desired antilogarithmic value by referring to the table when the determining portion determines that the desired antilogarithmic value is included in the predetermined range. A second logarithmic-value calculating portion calculates the desired logarithmic value based on a linear function when the determining portion determines that the desired antilogarithmic value is outside the predetermined range.

### CROSS REFERENCE TO RELATED APPLICATIONS

This application claims priority from Japanese Patent Application No. 2006-264470 filed Sep. 28, 2006. The entire content of the priority application is incorporated herein by reference.

### TECHNICAL FIELD

The invention relates to an image processing device, an image processing method, and a storage medium storing an image processing program, and more specifically to an image processing device, an image processing method, and a storage medium storing an image processing program that performs a Retinex process on an image.

### BACKGROUND

When taking a photograph of a subject under backlit conditions, e.g. against the sun, the image of the subject portion is an indistinct backlit image with low lightness and contrast, making it difficult to make out details of the subject. Image processing is performed to improve the quality of these backlit images, as well as images suffering in quality due to overexposure, underexposure, blurring due to jiggling when capturing the image, noise, insufficient light, and the like, in order to improve lightness and contrast in the image. One method used in conventional image processing is a Retinex process.

The Retinex process preserves the input image data for high-quality regions and improves the image quality primarily in low-quality regions. The Retinex process uses Gaussian filters for correcting pixel data in the original image to values reflecting data of peripheral pixels, calculates reference component data for the original image from the natural logarithm of the calibrated pixel data, and calculates luminance component data by dividing pixel data of the original image by pixel components of the original image. Specifically, this process divides the original image into reference components and luminance components. Next, a process is performed to calibrate the brightness and level (contrast) of the luminance component through gamma correction or the like and subsequently generates improved image data for the original image in backlit portions and the like by combining the calibrated luminance components with the reference components. The reference component is found by normalizing a reflectance R(x, y).

### SUMMARY

The Retinex process requires a long time to perform logarithm calculations for obtaining the reference components. U.S. Pat. No. 6,947,176 (corresponding to Japanese Patent Application Publication No. 2001-78025) discloses a method of approximating logarithm calculations by a plurality of linear functions in correcting luminance of an image.

However, the above-described method employs interpolations using the plurality of linear functions in logarithm calculations for obtaining reflectance in the Retinex process. This causes the following problems in regions where a rate of change in reflectance with respect to inputted luminance is large. That is, if the same interpolation interval is used for regions where the rate of change is small and for regions where the rate of change is large, errors in calculated reflectance become large in the regions where the rate of change is large. On the other hand, if a small interpolation interval is used for regions where the rate of change is large for maintaining higher accuracy, a large number of linear functions are required for many small regions, leading to a long calculation period.

In view of the foregoing, it is an object of the invention to provide an image processing device, an image processing method, and a storage medium storing an image processing program that is capable of performing logarithm calculations in the Retinex process accurately and quickly both for a region in which a rate of change in reflectance with respect to luminance inputs is large and for a region in which the rate of change in reflectance with respect to luminance inputs is not large.

In order to attain the above and other objects, the invention provides an image processing device. The image processing device includes a storage unit, an antilogarithmic-value calculating portion, a determining portion, a first logarithmic-value calculating portion, and a second logarithmic-value calculating portion. The storage unit stores a table including a plurality of logarithmic values corresponding to respective ones of a plurality of antilogarithmic values. The antilogarithmic-value calculating portion divides a pixel value of a subject pixel in an original image by a peripheral average luminance of the subject pixel, thereby calculating a desired antilogarithmic value. The determining portion determines whether the desired antilogarithmic value is included in a predetermined range. The first logarithmic-value calculating portion calculates a desired logarithmic value corresponding to the desired antilogarithmic value by referring to the table when the determining portion determines that the desired antilogarithmic value is included in the predetermined range. The second logarithmic-value calculating portion calculates the desired logarithmic value based on a linear function when the determining portion determines that the desired antilogarithmic value is outside the predetermined range.

According to another aspect, the invention also provides a storage medium storing a set of program instructions executable on an image processing device. The set of program instructions includes: calculating a desired antilogarithmic value by dividing a pixel value of a subject pixel in an original image by a peripheral average luminance of the subject pixel; determining whether the desired antilogarithmic value is included in a predetermined range; calculating a desired logarithmic value corresponding to the desired antilogarithmic value by referring to a table when it is determined that the desired antilogarithmic value is included in the predetermined range, the table including a plurality of logarithmic values corresponding to respective ones of a plurality of antilogarithmic values; and calculating the desired logarithmic value based on a linear function when it is determined that the desired antilogarithmic value is outside the predetermined range.

According to another aspect, the invention also provides an image processing method. The image processing method includes: calculating a desired antilogarithmic value by dividing a pixel value of a subject pixel in an original image by a peripheral average luminance of the subject pixel; determining whether the desired antilogarithmic value is included in a predetermined range; calculating a desired logarithmic value corresponding to the desired antilogarithmic value by referring to a table when it is determined that the desired antilogarithmic value is included in the predetermined range, the table including a plurality of logarithmic values corresponding to respective ones of a plurality of antilogarithmic values; and calculating the desired logarithmic value based on a linear function when it is determined that the desired antilogarithmic value is outside the predetermined range.

### BRIEF DESCRIPTION OF THE DRAWINGS

In the drawings:

FIG. 1 is a block diagram showing the electrical structure of a printer having an image processing program according to a first embodiment of the invention;

FIG. 2A is a graph including a plurality of linear functions which is used for approximating a logarithmic function;

FIG. 2B is a graph illustrating an approximation method according to the first embodiment;

FIG. 2C shows histograms for a case when reflectance is obtained by the method of FIG. 2A, a case when the reflectance is obtained by the method of FIG. 28r and a case in which no approximation is performed;

FIG. 3 is a flowchart illustrating steps in a Retinex process of an image processing program executed by the printer according to the first embodiment;

FIG. 4 is a flowchart illustrating steps in a logarithmic calculation process according to the first embodiment;

FIG. 5A shows a table including both values obtained based on a linear function and actual logarithmic values in comparison;

FIG. 5B is a graph plotted from the both values shown in the table of FIG. 5A;

FIG. 6 shows a table including indices, antilogarithmic values, and logarithmic values according to a second embodiment of the invention; and

FIG. 7 is a flowchart illustrating steps in a logarithmic calculation process according to the second embodiment.

### DETAILED DESCRIPTION

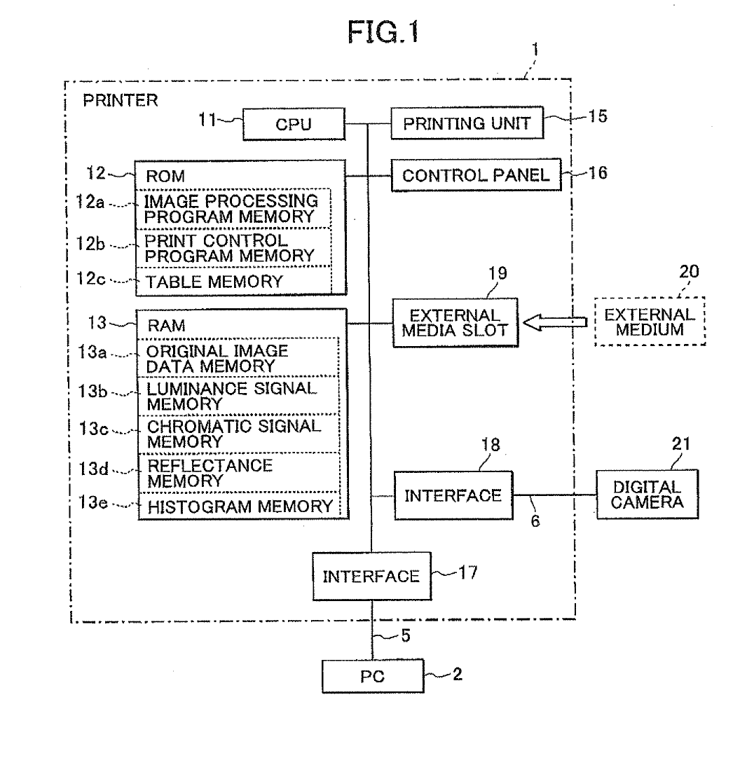

An image processing device, an image processing method, and a storage medium storing an image processing program according to a first embodiment of the invention will be described with reference to FIGS. 1 through 5B. FIG. 1 is a block diagram showing the electrical structure of a printer 1 having a function for performing an image process according to the first embodiment. In the first embodiment, the printer 1 is connected to a personal computer (hereinafter referred to as a “PC”) 2, a digital camera 21, and/or an external medium 20. An image processing program installed on the printer 1 executes a Retinex process on image data (image data for an original document or the like) inputted from the PC 2, digital camera 21, or external medium 20. The image processing program corrects low-quality regions of the image data, such as backlit image regions.

As shown in FIG. 1, the printer 1 includes a CPU 11, a ROM 12, a RAM 13, a printing unit 15, and a control panel 16. The printing unit 15 has a print head and the like for printing out image data on a printing medium, such as paper. The control panel 16 has a user operating unit configured of a ten-key pad and the like, for example, enabling the user to input values for the size of the outputted image and the like.

The printer 1 also includes an interface 17, an interface 18, and an external media slot 19. The interface 17 is provided for connecting the printer 1 to the PC 2 with a cable 5. The interface 10 is provided for connecting the printer 1 to the digital camera 21 with a cable 6. The external media slot 19 allows the user to detachably mount the external medium 20 in the printer 1, the external medium 20 being an SD card or a Memory Stick, for example. The interfaces 17 and 18 use the Universal Serial Bus (USB) communication method.

Accordingly, image data stored on the PC 2 can be inputted into the printer 1 via the cable 5 and the interface 17, while image data captured by the digital camera 21 can be inputted into the printer 1 via the cable 6 and the interface 18. Further, image data stored on the external medium 20 can be inputted into the printer 1 when the external medium 20 is mounted in the external media slot 19.

The CPU 11 is an arithmetic processor that controls the overall operations of the printer 1. The ROM 12 stores various control programs executed by the CPU 11 and fixed values used when the CPU 11 executes programs. The ROM 12 includes an image processing program memory 12a, a print control program memory 12b, and a table memory 12c, and the like. The image processing program memory 12a stores the image processing program for performing such image processing as the Retinex process. The print control program memory 12b stores a print control program for executing a printing operation. The image processing program includes logarithmic calculation process in the Retinex process. The table memory 12c stores logarithmic values in correspondence with antilogarithmic values. The CPU 11 refers to the table memory 12c in the logarithmic calculation process.

The RAM 13 is a rewritable random access memory that includes a work area for storing a set of registers required when the CPU 11 executes the control programs, and a temporary area for temporarily storing data during such processes. The RAM 13 includes an original image data memory 13a, a luminance signal memory 13b, a chromatic signal memory 13c, a reflectance memory 13d, and a histogram memory 13e.

The original image data memory 13a stores original image data. More specifically, the original image data memory 13a stores image data inputted from the PC 2, digital camera 21, and external medium 20 via the interface 17, interface 18, and external media slot 19, respectively. In the present embodiment, the original image data and output image data are configured of RGB values, each of which is a value in the range 0-255.

Specifically, the RGB values include components representing the three primary colors of light, i.e. an R value representing red, a G value representing green, and a B value representing blue. The combination of RGB values for each pixel of an input image indicates one color (hue, tone, etc.). The greater the RGB values, the higher the luminance (brightness).

The original image data is separated into luminance signals Y and chromatic signals Cb and Cr. The luminance signal memory 13b stores the luminance signals Y. The chromatic signal memory 13c stores the chromatic signals Cb and Cr. The Retinex process is performed only on the luminance signals Y. After the Retinex process, the Retinex-processed luminance signals and the chromatic signals Cb and Cr are used to again obtain color image data.

The reflectance memory 13d stores reflectance R(x, y) that are obtained by performing the Retinex process only on the luminance signals of the original image. The CPU 11 calculates a reflectance value for each pixel in the original image and stores the reflectance value in the reflectance memory 13d. In this calculation, a pixel value of a subject pixel is divided by a peripheral average luminance which is an average luminance value of peripheral pixels. Then, the CPU 11 calculates a natural logarithm of this value which serves as an antilogarithm, and stores calculated values in the reflectance memory 13d. This logarithmic calculation can be performed quickly and accurately according to the present embodiment.

When the reflectance R(x, y) is normalized, a histogram is formed in the histogram memory 13e for obtaining a clipped range described later. That is, the histogram memory 13e stores frequencies of the reflectance of each pixel.

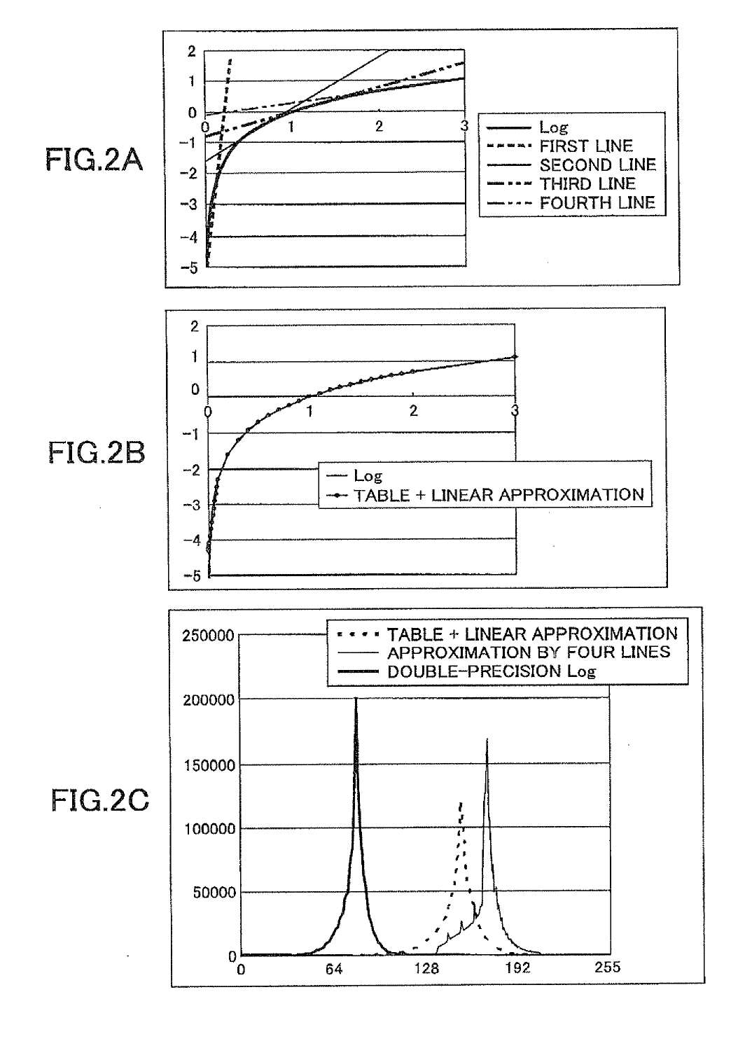

A method for approximating logarithmic calculations in the Retinex process is described with reference to FIGS. 2A through 2C. FIG. 2A shows a case in which a plurality of linear functions is used for approximation. FIG. 2B shows a case in which an approximation method according to the present embodiment is used. FIG. 2C shows histograms for a case when the reflectance R(x, y) is obtained by the method of FIG. 2A, a case when the reflectance R(x, y) is obtained by the method of FIG. 2B, and a case in which no approximation is performed.

In graphs shown in FIGS. 2A and 2B, a horizontal axis indicates antilogarithmic values from 0 to 3, while a vertical axis indicates logarithmic values from −5 to 2. In this example, the antilogarithmic values often take values proximate to 1.0 because the antilogarithmic values are ratios of the luminance value of the subject pixel to the luminance value of peripheral pixels. Hence, logarithmic values of most pixels can be obtained in the range shown in FIGS. 2A and 2B.

In FIG. 2A, a bold solid line shows a logarithmic curve which is approximated by four lines (four linear functions). A thick dashed line represents a first line. A thin solid line represents a second line. A thick double-dot chain line represents a third line. A thin double-dot chain line represents a fourth line. As shown in FIG. 2A, discrepancies between the logarithmic curve and the approximation lines are relatively large in regions near intersections of the approximation lines.

As shown in FIG. 2B, according the present embodiment, a solid line shows the logarithmic curve. Dots in FIG. 2B show values that are stored in a table and referred to when the antilogarithmic values are from 0.1 to 2.0. A first linear function is used for approximation when the antilogarithmic values are greater than 2.0. A second linear function is used for approximation when the antilogarithmic values are less than 0.1. Here, the first and second linear functions are different ones from the first through fourth lines in FIG. 2A. Although not specifically shown in FIG. 2B, the table stores logarithmic values for antilogarithmic values at intervals of 0.1. When the antilogarithmic values have a hundredth digit (two digits after decimal point), values stored in the table are used for linear interpolation to obtain logarithmic values.

The graph in FIG. 2C shows a histogram when reflectance R(x, y) is obtained for an image (not shown) taken by a digital camera. In FIG. 2C, a horizontal axis indicates values obtained by normalizing reflectance R(x, y) to integers of 0-255. A vertical axis indicates numbers of pixels having each value of reflectance R(x, y). A bold solid curve shows a histogram obtained by using double-precision logarithmic values. A thin solid curve shows a histogram obtained by using the four lines in FIG. 2A for approximation. A dashed curve shows a histogram obtained by using the method of the present embodiment shown in FIG. 2B.

In a normal natural image (a landscape or portrait image), zero (0) reflectance is the largest number of all reflectance values. In FIG. 2C, a mode value (a reflectance value having the largest number) of each histogram corresponds to a reflectance value (logarithmic value) of zero (0) i.e., an antilogarithmic value of 1.0. Also, each histogram has approximately equal values around the mode value (equal values at left and right sides of the mode value). Hence, Retinex-processed reflectance values are centered on the antilogarithmic value of 1.0 (median value) with respect to frequency of occurrence.

Further, in FIG. 2C, the histogram obtained by double-precision logarithmic values and the histogram obtained by the method of the present embodiment have substantially equivalent shapes and are configured of smooth curves. In contrast, the histogram obtained by approximation based on the four lines has some irregularities (i.e., some protrusions appear), which means the approximation based on the four lines cannot ensure accuracies.

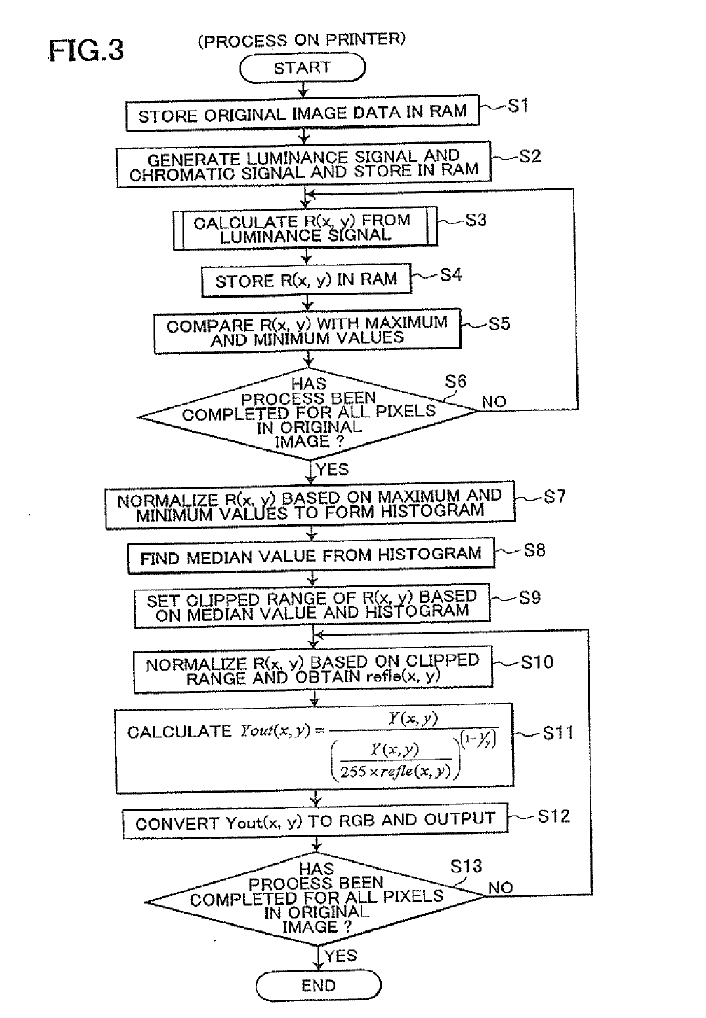

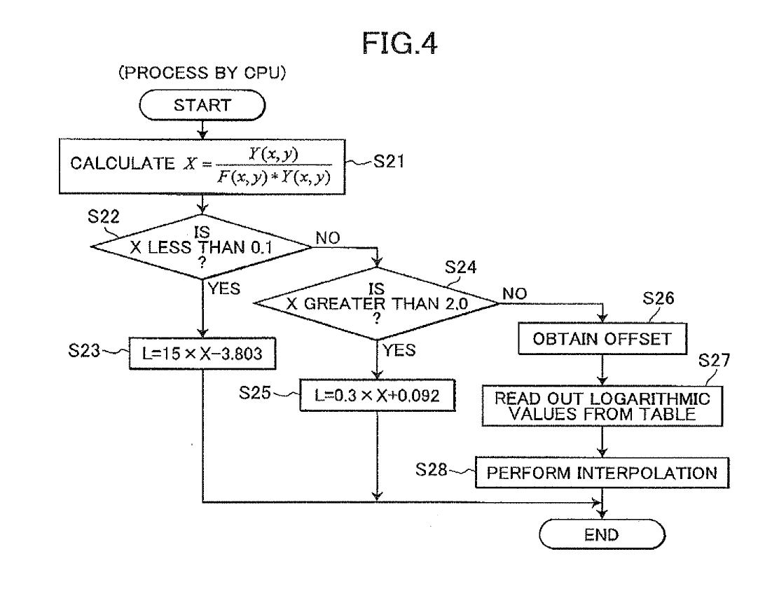

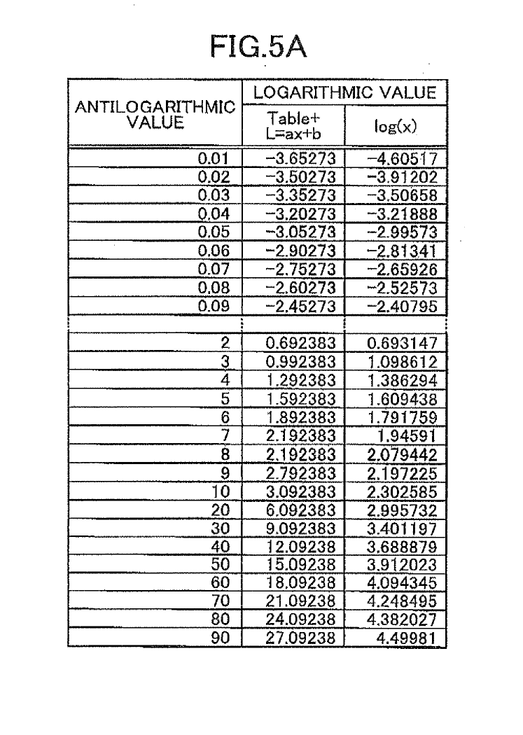

The Retinex process according to the present embodiment will be described with reference to FIGS. 3 and 4. FIG. 3 is a flowchart illustrating steps in the Retinex process. FIG. 4 is a flowchart illustrating steps in a logarithmic calculation process shown in step S3 in FIG. 3. Steps are hereinafter abbreviated as “S”.

In the Retinex process, first, luminance values are obtained from a color image. Then, after the Retinex process is performed only on the luminance values, a color image is again obtained using the Retinex-processed luminance values. In this way, a color shift or the like can be prevented.

In S1 of FIG. 3, the CPU 11 reads original image data from the PC 2 or digital camera 21 and stores this data in the original image data memory 13a of the RAM 13. In S2 the CPU 11 converts RGB values for each pixel in the original image to a luminance value (luminance signal) Y and chromatic values (chromatic signals) Cb and Cr. The following equation is used to calculate the luminance value Y and the chromatic values Cb and Cr

$$( \begin{matrix}Y \\ Cb \\ Cr\end{matrix} ) = ( \begin{matrix}0.30 & 0.59 & 0.11 \\ - 0.17 & - 0.34 & 0.51 \\ 0.51 & - 0.43 & - 0.08\end{matrix} ) ( \begin{matrix}R \\ G \\ B\end{matrix} ) \qquad [ Equation 1 ]$$

In this case, the CPU 11 stores the luminance value Y in the luminance signal memory 13b, and stores the chromatic values Cb and Cr in the chromatic signal memory 13c.

In S3 the CPU 11 calculates a reflectance R(x, y) from the luminance value Y calculated above for each pixel in the original image. The reflectance R(x, y) is calculated according to the following equation.

$$R ( x , y ) = log \frac{Y ( x , y )}{F ( x , y ) * Y ( x , y )} \qquad [ Equation 2 ]$$

In equation 2, x is the horizontal coordinate and y is the vertical coordinate in the original image, Y(x, y) is the luminance value of the pixel at the coordinate (x, y), “*” the convolution operator. Further, log is the natural logarithm to the base e. F(x, y) represents a Gaussian filter factor at the subject pixel (x, y) as shown in the following equation.

F(x,y)=exp(−(x²+y²)/(c/75)²) [Equation 3]

where c is a coefficient determined dependently on the number of the peripheral pixels. So, the value F(x, y)*Y(x, y) indicates the average value of the luminance values of the peripheral pixels (peripheral average luminance). Note that the Gaussian filter factors F(x, y) are set in accordance with distance between each of the peripheral pixels and the subject pixel. A total of the Gaussian filter factors F(x, y) equals to 1.0. The coefficient C is a parameter which determines the degree of the extent of Gaussian distribution.

The above logarithmic calculation will be described in greater detail with reference to FIG. 4.

In S4 the CPU 11 stores the reflectance R(x, y) found in the above calculations in the reflectance memory 13d of the RAM 13.

In S5 the CPU 11 compares the reflectance R(x, y) obtained in S3 to maximum and minimum values of reflectance R(x, y) values obtained thus far. Specifically, both of the maximum and minimum values are temporarily set to the reflectance R(x, y) found for the first-calculated pixel. All reflectance R(x, y) values subsequently obtained are compared with the current maximum and minimum values. If the current reflectance R(x, y) is greater than the maximum value, then this reflectance R(x, y) is set as the new maximum value. Similarly, if the current reflectance R(x, y) is less than the minimum value, then this reflectance R(x, y) is set as the new minimum value. When the current reflectance R(x, y) is less than or equal to the maximum value and greater than or equal to the minimum value, the maximum and minimum values remain unchanged.

In S6 the CPU 11 determines whether the process in S3-S5 has been completed for all coordinates in the original image. If unprocessed coordinates remain (S6: NO), the CPU 11 returns to S3. However, if the process has been completed for all coordinates (S6: YES), then in S7 the CPU 11 normalizes the reflectance R(x, y) values based on the maximum and minimum values obtained in S5 to form a histogram. Normalization is achieved by setting the minimum reflectance R(x, y) among all coordinates to 0 and the maximum value to 255 and linearly setting all reflectance R(x, y) values for other coordinates to integers between 0 and 255. The histogram is formed in the histogram memory 13e by tabulating the frequency of pixels indicating each computed value between the maximum and minimum values.

In S8 the CPU 11 finds a median value M from the histogram formed in S7. In S9 the CPU 11 sets a clipped range of reflectance R(x, y) values (normalizing parameters) based on the median value M and the histogram. As an example, the clipped range has an upper limit U including 45% of all samplings greater than the median value M, and a lower limit D including 45% of all samplings smaller than the median value M. The reflectance R(x, y) values corresponding to the upper limit U and lower limit D are called the UpR and DownR values, respectively. In this way, a clipped range (UpR, DownR) is obtained.

In the process described above, the CPU 11 forms a Retinex image configured by the reflectance of the original image and finds the clipped range for normalizing the reflectance of the original image from the Retinex image.

In S10 the CPU 11 normalizes the reflectance R(x, y) values stored in the reflectance memory 13d within the clipped range (UpR, DownR) found in S9, in order to find normalized reflectance (normalized Retinex value) refle(x, y).

More specifically, when each histogram in FIG. 2C obtained from the same digital photograph data is normalized, mode values and median values in the horizontal axis are identical between the normalized histograms. Further, a central value of the normalized reflectance corresponds to an antilogarithmic value of 1.0.

Comparing an envelop of the double-precision logarithm histogram (a shape of the bold solid curve) and an envelop of the histogram according to the present embodiment (a shape of the dashed curve), the positions of mode values and widths spreading left and right from the mode values are different between both histograms. However, shapes of the envelops are similar between both histograms. Accordingly, it is assumed that both graphs obtained by normalizing reflectance R(x, y) and converting the reflectance into normalized reflectance (normalized Retinex value) refle(x, y) are substantially identical.

The normalized reflectance refle(x, y) is set to 0.0 when the value of reflectance R(x, y) is less than or equal to DownR, set to 1.0 when the value of reflectance R(x, y) is greater than or equal to UpR, and calculated from equation 4 shown below when the value of reflectance R(x, y) is greater than DownR and less than UpR.

$$refle ( x , y ) = \frac{R ( x , y ) - DownR}{UpR - DownR} \qquad [ Equation 4 ]$$

Through this process, refle(x, y) is normalized to a value between 0.0 and 1.0. Through experimentation, it has been found preferable to add 0.3 to this value to obtain a value between 0.3 and 1.3 for refle(x, y).

In S11 the CPU 11 finds an output luminance value Yout(x, y) according to equation 5 shown below. In other words, the CPU 11 performs the Retinex process on the luminance value for each pixel in the original image. In equation 5, γ is a gamma constant.

$$Yout ( x , y ) = \frac{Y ( x , y )}{{( \frac{Y ( x , y )}{255 \times refle ( x , y )} )}^{( 1 - 1 / γ )}} \qquad [ Equation 5 ]$$

In S12 the CPU 11 converts YCbCr values to RGB values based on equation 6 shown below. Yout in equation 6 corresponds to Yout x, y) in equation 5. Cr and Cb in equation 6 correspond to Cr and Cb in equation 1. Note that a coordinate (x, y) is omitted in equation 6 for simplification.

$$( \begin{matrix}R \\ G \\ B\end{matrix} ) = ( \begin{matrix}1.0 & 0 & 1.37 \\ 1.0 & - 0.34 & - 0.70 \\ 1.0 & 1.73 & 0\end{matrix} ) ( \begin{matrix}Yout \\ Cb \\ Cr\end{matrix} ) \qquad [ Equation 6 ]$$

If the printer 1 is set such that a processed image is outputted to the printing unit 15, processed pixel values are outputted to the printing unit 15. In S13 the CPU 11 determines whether the process has been completed for all the pixels in the original image. If there are still unprocessed pixels (S13: NO), then the CPU 11 returns to S10. If the process has been completed for all the pixels (S13: YES), then the Retinex process shown in FIG. 3 ends.

The logarithmic calculation process of S3 in FIG. 3 will be described below with reference to FIG. 4. FIG. 4 is a flowchart illustrating steps in the logarithmic calculation process. In the logarithmic calculation process, the table stored in the table memory 12c is referred to when an antilogarithmic value is greater than or equal to 0.1 and is less than or equal to 2.0, while a logarithmic value is obtained from a linear function when an antilogarithmic value is less than 0.1 or is greater than 2.0. The table stores logarithmic values (natural logarithm) corresponding to antilogarithmic values between 01 and 2.0 at regular intervals of 0.1. In reality, the table memory 12c stores only an initial address of the table and the logarithmic values in the order of the address. The CPU 11 calculates an offset and reads out a logarithmic value corresponding to the offset, as described below.

In S21 the CPU 11 divides a luminance value Y(x, y) of the subject pixel by a peripheral average luminance F(x, y)*Y(x, y) in order to obtain an antilogarithmic value X (desired antilogarithmic value).

In S22 the CPU 11 determines whether the antilogarithmic value X is less than 0.1. If the antilogarithmic value X is less than 0.1 (S22: YES), then in S23 the CPU 11 finds a logarithmic value L (desired logarithmic value) based on the following equation.

L=15×X−3.803 [Equation 7]

If the antilogarithmic value X is greater than or equal to 0.1 (S22: NO), then in S24 the CPU 11 determines whether the antilogarithmic value X is greater than 2.0. If the antilogarithmic value X is greater than 2.0 (S24: YES), then in S25 the CPU 11 finds the logarithmic value L based on the following equation.

L=0.3×X+0.092 [Equation 8]

If the antilogarithmic value X is not greater than 2.0 (S24: No), which means the antilogarithmic value X is greater than or equal to 0.1 and is less than or equal to 2.0, then in S26 the CPU 11 finds, based on the antilogarithmic value X, an address at which a logarithmic value L to be read out is stored. The address is specified by an offset A counted from an initial address of the table. The offset A is obtained by multiplying the antilogarithmic value X by ten (10) and then truncating digits after decimal point.

In S27 the CPU 11 reads out both a logarithmic value Bn specified by the offset A and a logarithmic value Bm specified by an address immediately after an address of the logarithmic value Br. In other words, the CPU 11 reads out, from the table, two logarithmic values corresponding to antilogarithmic values that surround (sandwich) the antilogarithmic value X. In S28 the CPU 11 finds a logarithmic value L by performing interpolation based on the following equation.

L=(Bm−Bn)×(10×X−A)+Bn [Equation 9]

When the CPU 11 completes the process in S23, S25, or S28, the logarithmic calculation process shown in FIG. 4 ends.

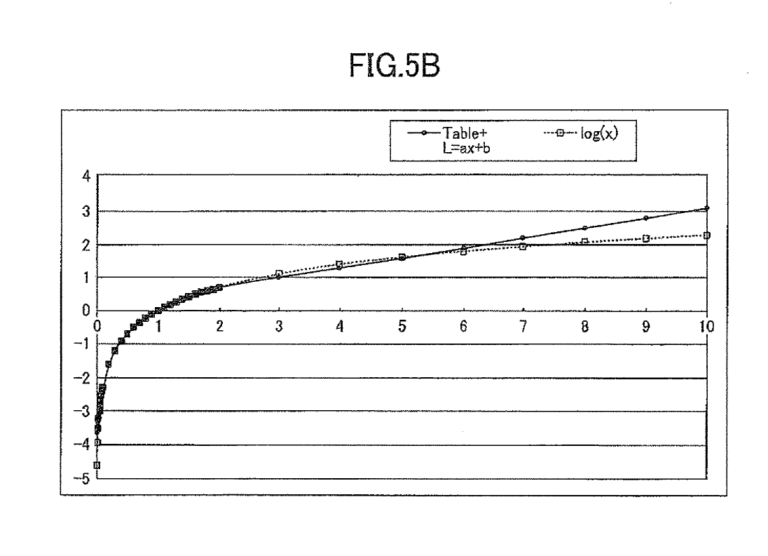

FIG. 5A shows a table including both values obtained based on the linear functions (Equations 7 and 8) according to the above-described method and actual logarithmic values in comparison. A first column (left column) in the table includes antilogarithmic values in a range from 0.01 to 0.09 and a range from 2 to 90. A second column (center column) includes values which are obtained from the linear functions corresponding to the antilogarithmic values in the first column. A third column (right column) includes the actual logarithmic values.

FIG. 5B is a graph plotted from the values shown in the table of FIG. 5A. In the graph, a horizontal axis indicates antilogarithmic values between 0 and 10, and a vertical axis indicates logarithmic values between −5 and 4. A dashed curve indicates the actual logarithmic values, while a solid curve indicates values obtained by the above-described logarithmic calculation process.

As shown in FIGS. 5A and 5B, when the antilogarithmic value is greater than or equal to 7, considerable differences are seen between the logarithmic values obtained from the linear function and the actual logarithmic values. However, since the antilogarithmic values are mostly proximate to 1.0, no practical problems will occur.

As described above, in the logarithmic calculation process in the Retinex process according to the first embodiment, values in the table are referred to when the antilogarithmic value is in a range between 0.1 and 2.0, while the logarithmic value is obtained from linear functions when the antilogarithmic value is outside the above range.

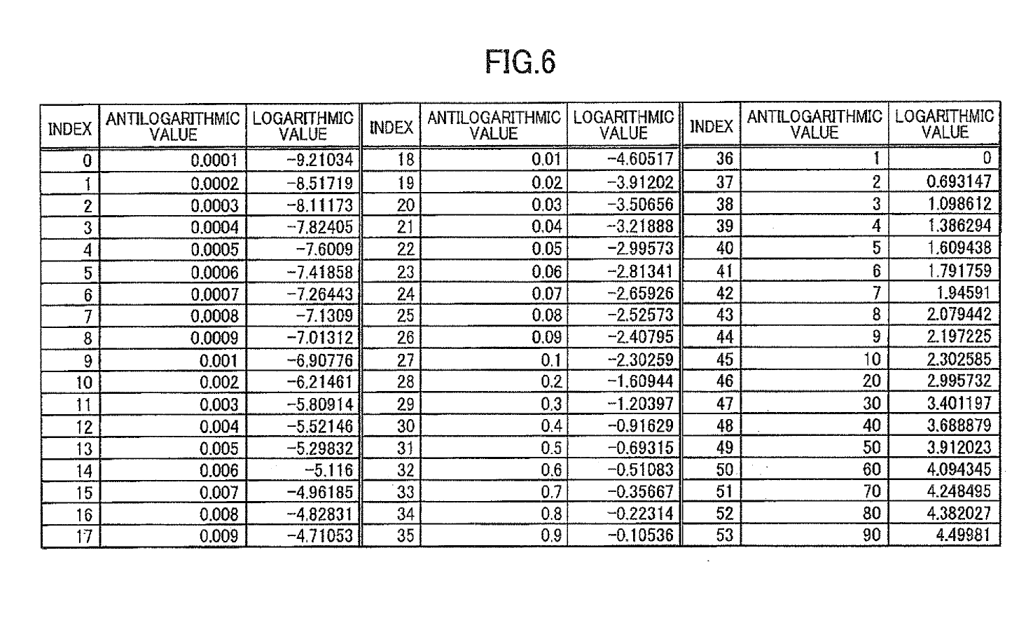

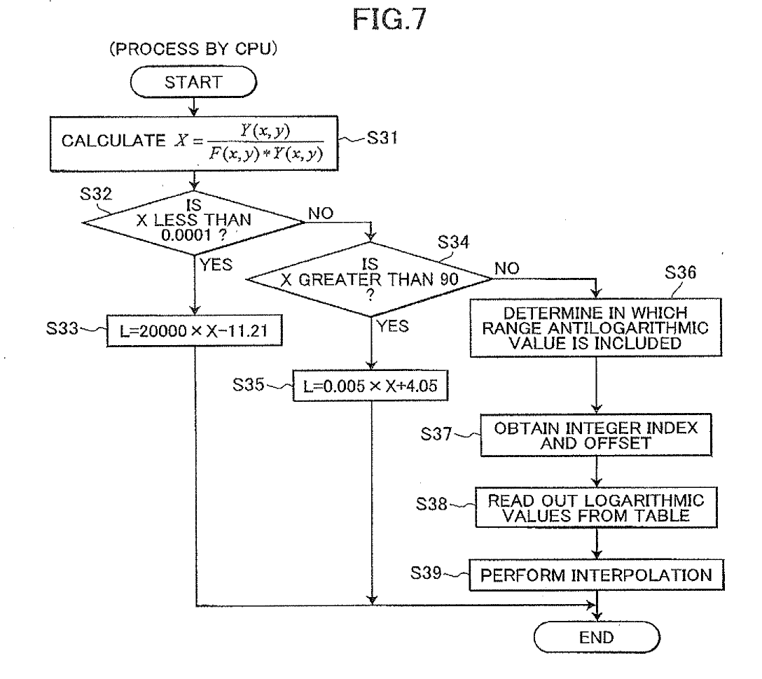

An image processing device, an image processing method, and a storage medium storing an image processing program according to a second embodiment of the invention will be described with reference to FIGS. 6 and 7. The second embodiment is different form the first embodiment in the logarithmic calculation processes shown in FIGS. 4 and 7 and in tables which are referred to in the processes of FIGS. 4 and 7. However, the other configurations are identical between the first and second embodiments, and like parts and components are designated by the same reference numerals to avoid duplicating description.

As described above, in the first embodiment, values in the table are referred to when the antilogarithmic value is in a range between 0.1 and 2.0. In the second embodiment, logarithmic values corresponding to antilogarithmic values in a wider range are stored in a table. In this case, if the table stores logarithmic values and corresponding antilogarithmic values in small regular intervals, a large storage space is required. In contrast, if the table stores logarithmic values and corresponding antilogarithmic values in large regular intervals, accuracy cannot be ensured when the antilogarithmic values are small. Accordingly, in the second embodiment, the table stores logarithmic values and corresponding antilogarithmic values in small intervals in a range where the antilogarithmic values are small, and stores logarithmic values and corresponding antilogarithmic values in large intervals in a range where the antilogarithmic values are large.

FIG. 6 shows a table storing logarithmic values and corresponding antilogarithmic values in a range that is greater than or equal to 0.0001 and is less than or equal to 90. The table stores indices (offsets), antilogarithmic values, and logarithmic values starting from left upper cells. In reality, the table memory 12c stores only an initial address of the table and the logarithmic values in the order of the address. The CPU 1L calculates an offset and reads out a logarithmic value corresponding to the offset.

In this example, the table stores logarithmic values corresponding to antilogarithmic values at intervals of 0.0001 in a range where the antilogarithmic values are in a range from 0.0001 to 0.001. Also, the table stores logarithmic values corresponding to antilogarithmic values at intervals of 0.001 in a range where the antilogarithmic values are in a range from 0.001 to 0.01, and the like. A method for obtaining logarithmic values based on this table will be described below.

In S31 the CPU 11 divides a luminance value Y(x, y) of the subject pixel by a peripheral average luminance F(x, y)*Y(x, y) in order to obtain an antilogarithmic value X.

In 332 the CPU 11 determines whether the antilogarithmic value X is less than 0.0001. If the antilogarithmic value X is less than 0.0001 (S32: YES), then in S33 the CPU 11 finds a logarithmic value L based on the following equation.

L=20000×X−11.21 [Equation [10]

If the antilogarithmic value X is greater than or equal to 0.0001 (S32: NO) then in S34 the CPU 11 determines whether the antilogarithmic value X is greater than 90. If the antilogarithmic value X is greater than 90 (S34: YES), then in S35 the CPU 11 finds the logarithmic value L based on the following equation.

L=0.005×X+4.05 [Equation [11]

If the antilogarithmic value X is not greater than 90 (S34: NO), which means the antilogarithmic value X is greater than or equal to 0.0001 and is less than or equal to 90, in S36 the CPU 11 determines in which range the antilogarithmic value X is included. A plurality of ranges include the following six ranges:

a first range from 0.0001 to 0.001 (excluding 0.001);

a second range from 0.001 to 0.01 (excluding 0.01);

a third range from 0.01 to 0.1 (excluding 0.1);

a fourth range from 0.1 to 1.0 (excluding 1.0);

a fifth range from 1.0 to 10 (excluding 10); and

a sixth range from 10 to 90.

As shown in FIG. 6, the table includes the logarithmic values corresponding to respective ones of the antilogarithmic values in predetermined intervals that are different depending on the range. More specifically, an interval of 0.0001 is used for the first range, an interval of 0.001 is used for the second range, and the like.

When the range has been determined, in S37 the CPU 11 divides the antilogarithmic value X by an integer index which is an initial value of each range (for example, the integer index is 0.001 when the range is the second range). Then the CPU 11 finds an offset A within each range by dividing the antilogarithmic value X by the integer index and then truncating digits after decimal point.

In S38 the CPU 11 reads out both a logarithmic value Bn specified by the offset A found in S37 and a logarithmic value Bm specified by an address immediately after an address of the logarithmic value Bn. In 539 the CPU 11 finds a logarithmic value L by performing interpolation based on the following equation.

L=(Bm−Bn)×(Q−A)+Bn[Equation 12]

In Equation 12, Q denotes a quotient obtained by dividing the antilogarithmic value X by the integer index. When the CPU 11 completes the process in S33, S35, or S39, the logarithmic calculation process shown in FIG. 7 ends.

A specific example of the logarithmic calculation process shown in FIG. 7 will be described. The example is a case where the antilogarithmic value X of 0.38 is obtained in S31. In S32 a NO determination is made because the antilogarithmic value X is greater than 0.0001. In S34 another NO determination is made because the antilogarithmic value X is less than 90. In S36 the CPU 11 determines that the antilogarithmic value X is included in the fourth range from 0.1 to 1.0.

In S37 the CPU 11 determines that the integer index is 0.1. The CPU 11 divides the antilogarithmic value X (038) by the integer index (0.1) to obtain the quotient Q (3.8). Then the CPU 11 finds the offset A (3) by truncating digits after decimal point of the quotient Q (3.8). Then, the CPU 11 adds a value of A-1 (3−1=2) to an address of the antilogarithmic value 0.1, thereby obtaining an address of the logarithmic value Bn. An address immediately after the address of the logarithmic value Bn is an address of the logarithmic value Bm. The logarithmic value L is found by the following equation.

L(Bm−Bn)×(3.8−3)+Bn [Equation 13]

In the above-described logarithmic calculation process according to the second embodiment, calculations are somewhat complicated compared to the first embodiment since it needs to be determined in which range the antilogarithmic value X is included. However, accuracy in the calculations is higher than that of the first embodiment.

As described above, according to the logarithmic calculation processes of the first and second embodiments, a logarithmic value is obtained by referring to a table for a predetermined range of a antilogarithmic value, while a logarithmic value is approximated by a linear function for an antilogarithmic value outside the predetermined range. Thus, the calculations can be performed at a high speed while maintaining accuracy.

While the invention has been described in detail with reference to the above aspects thereof, it would be apparent to those skilled in the art that various changes and modifications may be made therein without departing from the scope of the claims.

In the above-described embodiments, the peripheral average luminance is defined as the value F(x, y)*Y(x, y) (Equation 2) which is a convolution of a filter coefficient F(x, y) and luminance value Y(x, y). However, an optically unfocused blurred image described in Japanese Patent No. 3731577 may be used as the peripheral average luminance. Alternatively, an image obtained by photographing the same object in a lower resolution may also be used as the peripheral average luminance.

In the above-described embodiments, the RGB color system is used, but a color system other than the RGB color system may be used. For example, the invention may be applied to the CMY color model or the like.

In the above-described embodiments, a luminance value Y is calculated from pixel values (RGB) of a color image, then a Retinex process is performed on the luminance value Y. However, the Retinex process may be performed on each of RGB values. In this case, the logarithmic calculation process described above can be applied to each of RGB values.

In the above-described first embodiment, a logarithmic value is obtained by reading out two values from a table and performing linear interpolation. However, the logarithmic value may be directly read out from a table. In this case, it is preferable that the table store logarithmic values corresponding to antilogarithmic values in smaller intervals such as 0.05, and that a logarithmic value corresponding to a value closest to the antilogarithmic value be read out.

In the above-described embodiment, the CPU 11 provided in the printer 1 executes the image processing program. However, this program may be provided to a personal computer as an application program that is executed by a CPU or the like provided in the personal computer. Further, the program may be executed by a multifunction peripheral having a plurality of functions including printer, scanner, copier, facsimile, and the like.

Either the single-scale Retinex (SSR) or multi-scale Retinex (MSR) method may be used in the Retinex process.

In the above-described embodiment, the CPU 11 in the printer 1 performs the Retinex process and the like. However, these processes may be performed with a digital signal processor (DSP). The DSP can be used to execute product-sum operations and other operations more quickly.

What is claimed is:

1. An image processing device comprising:
a storage unit that stores a table including a plurality of logarithmic values corresponding to respective ones of a plurality of antilogarithmic values;
an antilogarithmic-value calculating portion that divides a pixel value of a subject pixel in an original image by a peripheral average luminance of the subject pixel, thereby calculating a desired antilogarithmic value;
a determining portion that determines whether the desired antilogarithmic value is included in a predetermined range;
a first logarithmic-value calculating portion that calculates a desired logarithmic value corresponding to the desired antilogarithmic value by referring to the table when the determining portion determines that the desired antilogarithmic value is included in the predetermined range; and
a second logarithmic-value calculating portion that calculates the desired logarithmic value based on a linear function when the determining portion determines that the desired antilogarithmic value is outside the predetermined range.

2. The image processing device according to claim 1, wherein the antilogarithmic-value calculating portion performs a convolution calculation between pixel values of peripheral pixels of the subject pixel and filter factors that are set in accordance with distance between each of the peripheral pixels and the subject pixel, thereby obtaining the peripheral average luminance, a total of the filter factors being a value of 1.0; and
wherein the predetermined range is a range including an antilogarithmic value of 1.0.

3. The image processing device according to claim 2, wherein the predetermined range is a range from 0.1 to 2.0.

4. The image processing device according to claim 1, wherein the first logarithmic-value calculating portion comprises:
a reading portion that reads out, from the table, two logarithmic values corresponding to antilogarithmic values that surround the desired antilogarithmic value; and
an interpolating portion that calculates the desired logarithmic value by interpolation using the two logarithmic values and the desired antilogarithmic value.

5. The image processing device according to claim 1, wherein the table includes the plurality of logarithmic values corresponding to respective ones of the plurality of antilogarithmic values at regular intervals.

6. The image processing device according to claim 1, wherein, when the determining portion determines that the desired antilogarithmic value is outside the predetermined range, the determining portion further determines whether the desired antilogarithmic value is either greater than the predetermined range or less than the predetermined range;
wherein the second logarithmic-value calculating portion calculates the desired logarithmic value based on a first linear function when the determining portion determines that the desired antilogarithmic value is greater than the predetermined range; and
wherein the second logarithmic-value calculating portion calculates the desired logarithmic value based on a second linear function when the determining portion determines that the desired antilogarithmic value is less than the predetermined range.

7. The image processing device according to claim 1, wherein the predetermined range includes a plurality of ranges,
further comprising a range selecting portion that selects one of the plurality of ranges in which the desired antilogarithmic value is included, when the determining portion determines that the desired antilogarithmic value is included in the predetermined range.

8. The image processing device according to claim 7, wherein the table includes the plurality of logarithmic values corresponding to respective ones of the plurality of antilogarithmic values in predetermined intervals, the predetermined intervals being different depending on the plurality of ranges.

9. A storage medium storing a set of program instructions executable on an image processing device, the set of program instructions comprising:
calculating a desired antilogarithmic value by dividing a pixel value of a subject pixel in an original image by a peripheral average luminance of the subject pixel;
determining whether the desired antilogarithmic value is included in a predetermined range;
calculating a desired logarithmic value corresponding to the desired antilogarithmic value by referring to a table when it is determined that the desired antilogarithmic value is included in the predetermined range, the table including a plurality of logarithmic values corresponding to respective ones of a plurality of antilogarithmic values; and
calculating the desired logarithmic value based on a linear function when it is determined that the desired antilogarithmic value is outside the predetermined range.

10. The storage medium according to claim 9, wherein the instructions for calculating a desired antilogarithmic value comprise performing a convolution calculation between pixel values of peripheral pixels of the subject pixel and filter factors that are set in accordance with distance between each of the peripheral pixels and the subject pixel, thereby obtaining the peripheral average luminance, a total of the filter factors being a value of 1.0; and
wherein the predetermined range is a range including an antilogarithmic value of 1.0.

11. The storage medium according to claim 10, wherein the predetermined range is a range from 0.1 to 2.0.

12. The storage medium according to claim 9, wherein the instructions for calculating a desired logarithmic value by referring to a table comprise:
reading out, from the table, two logarithmic values corresponding to antilogarithmic values that surround the desired antilogarithmic value; and
calculating the desired logarithmic value by interpolation using the two logarithmic values and the desired antilogarithmic value.

13. The storage medium according to claim 9, wherein the table includes the plurality of logarithmic values corresponding to respective ones of the plurality of antilogarithmic values at regular intervals.

14. The storage medium according to claim 9, wherein, when it is determined that the desired antilogarithmic value is outside the predetermined range, it is further determined whether the desired antilogarithmic value is either greater than the predetermined range or less than the predetermined range;
wherein the instructions for calculating the desired logarithmic value based on a linear function comprise calculating the desired logarithmic value based on a first linear function when it is determined that the desired antilogarithmic value is greater than the predetermined range; and
wherein the instructions for calculating the desired logarithmic value based on a linear function comprise calculating the desired logarithmic value based on a second linear function when it is determined that the desired antilogarithmic value is less than the predetermined range.

15. The storage medium according to claim 9, wherein the predetermined range includes a plurality of ranges,
wherein the set of program instructions further comprises selecting one of the plurality of ranges in which the desired antilogarithmic value is included when it is determined that the desired antilogarithmic value is included in the predetermined range.

16. The storage medium according to claim 15, wherein the table includes the plurality of logarithmic values corresponding to respective ones of the plurality of antilogarithmic values in predetermined intervals, the predetermined intervals being different depending on the plurality of ranges.

17. An image processing method comprising:
calculating a desired antilogarithmic value by dividing a pixel value of a subject pixel in an original image by a peripheral average luminance of the subject pixel;
determining whether the desired antilogarithmic value is included in a predetermined range;
calculating a desired logarithmic value corresponding to the desired antilogarithmic value by referring to a table when it is determined that the desired antilogarithmic value is included in the predetermined range, the table including a plurality of logarithmic values corresponding to respective ones of a plurality of antilogarithmic values; and
calculating the desired logarithmic value based on a linear function when it is determined that the desired antilogarithmic value is outside the predetermined range.
